(19) United States
(12) Patent Application Publication
(10) Pub. No.: US 2010/0164488 A1
(43) Pub. Date: Jul. 1, 2010

(54) ELECTROMAGNETIC PIEZOELECTRIC ACOUSTIC SENSOR

(76) Inventors: Christopher Robin Lowe, Cambridge (DE); Adrian Carl Stevenson, Cambridge (GB); Bernardita Araya-Kleinsteuber, Cambridge (GB)

Correspondence Address: FISH & RICHARDSON PC, P.O. BOX 1022, MINNEAPOLIS, MN, 55440-1022, US

(21) Appl. No.: 11/721,643

(22) PCT Filed: Dec. 13, 2005
(86) PCT No.: PCT/GB05/04797

§ 371 Date: Mar. 17, 2010

(30) Foreign Application Priority Data
Dec. 13, 2004 (GB) 0427271.2

(51) Int. Cl. G01N 27/72

(52) U.S. Cl. 324/239

(57) ABSTRACT

Provided is a remote sensing apparatus comprising: (a) an electromagnetic field detector and (b) an acoustic resonator comprising an electromagnetic field generator and a sensing material in wireless communication with the generator; wherein the sensing material is in wireless communication with the detector, and an acoustic property of the sensing material is responsive to a change in state of an environment to which the sensing material is exposed, and wherein the sensing material is in the form of one or more particles and/or fragments.

### FIELD OF INVENTION

The present invention concerns a remote sensing apparatus, in particular a remote sensor employing an acoustic resonator wirelessly coupled to a detector. The invention also relates to methods and devices employing the sensors. An advantage of the apparatus of the present invention is that the sensing element which is situated remotely in an environment to be investigated cannot run out of power or fail, since the intrinsic property of the material does not disappear. Accordingly, the sensor may be implanted in a remote environment without the need for subsequent explantation for maintenance. The sensing apparatus also exhibits improved and sharper resonances by employing smaller sensor fragments, with sensitivity enhanced 100 fold or more.

BACKGROUND TO THE INVENTION

Acoustic sensors that employ resonators have been used as detection devices for the past several decades, exhibiting sensitivity in the ng/ml range. They share with optical devices an ability to produce evanescent waves that propagate a limited distance across the solid liquid interface, so molecular events and processes in the bulk are not detected; only those processes leading to interfacial elasticity, viscosity, viscoelasticity and slippage are detected.

Acoustic wave sensors can be configured to measure the mechanical characteristics of a variety of molecular films in different chemical contexts. For example, acoustic sensitivity to surface forces has led to the detection of interfacial chemical changes that cause frequency and amplitude shifts that can be correlated to interface mass (Sauerbrey, G., 1959, “Use of quartz vibrator for weighing thin films on a microbalance” Z. Phys., 155, 206.), viscosity (Kanazawa, K. K. & Gordon, J. G., 1985, “The oscillation frequency of a quartz crystal resonator in contact with a liquid”, Analytica Chimica Acta, 175, 99-105), and viscoelasticity and slippage (Yang, M. S., Chung, F. L. & Thompson, M., 1993, “Acoustic network analysis as a novel technique for studying protein adsorption and denaturation at surfaces”, Analytical Chemistry, 65, 3713-3716; Rodahl, M., Hook, F., Krozer, A., Brzezinski, P. & Kasemo, B., 1995, “Quartz-crystal microbalance set-up for frequency and Q-factor measurements in gaseous and liquid environments”, Rodahl, M., Hook, F., Fredriksson, C., Keller, C. A., Krozer, A., Brzezinski, P., Voinova, M. & Kasemo, B., 1997, “Simultaneous frequency and dissipation factor QCM measurements of biomolecular adsorption and cell adhesion”; Faraday Discussions, 229-246). Also, sensitivity via the mechanical properties of hydrogel films has led to the detection of nucleotides through swelling behaviour (Kanekiyo, Y., et al., “Novel nucleotide-responsive hydrogels designed from copolymers of boronic acid and cationic units and their applications as a QCM resonator system to nucleotide sensing”, Journal of Polymer Science Part a—Polymer Chemistry, 2000. 38(8): p. 1302-1310), an enhanced sensing response to okadaic acid with an antibody-BSA hydrogel (Tang, A. X. J., et al., “Immunosensor for okadaic acid using quartz crystal microbalance”, Analytica Chimica Acta, 2002. 471(1): p. 33-40), an exposition of complex phase transitions within the hydrogel itself (Nakano, Y., Y. Seida, and K. Kawabe, “Detection of multiple phases in ecosensitive polymer hydrogel”, Kobunshi Ronbunshu, 1998. 55(12): p. 791-795) and a detailed analysis of a submicron thermo-responsive hydrogel film prepared by a stepwise assembly process (Serizawa, T., et al., “Thermoresponsive ultrathin hydrogels prepared by sequential chemical reactions”, Macromolecules, 2002. 35(6): p. 2184-2189).

Acoustic sensors offer significant advantages in view of their simplicity and their ability to respond to a variety of interfacial phenomena, such as DNA hybridisation, ligand-induced protein conformation change and antigen-antibody reactions. The magnetic acoustic resonant sensor (MARS) is one type of acoustic system that actuates simple glass plates by remotely generated electromagnetic waves, such that the electronics of the detection system can be separated from the device itself. This system has recently been developed with quartz plates to operate at multiple and hypersonic frequencies within the MHz-GHz range.

The MARS system can generate non-contact acoustic waves via two different induction mechanisms. The electromagnetic alternative for generating non-contact acoustic resonance in metals and in piezoelectric plates was first recognised as ‘noise’ appearing across NMR (nuclear magnetic resonance) detection coils. This electromagnetically induced piezoelectric resonance was reported by Hughes (Hughes D. G. and Pandey L. J., 1984. Magn. Reson. 56, 428) as an unwanted signal caused by the ringing of NaNO₂ crystals, and was later extended to the electromagnetically induced resonance of a 3.5 MHz AT crystal by Choi (Choi K. and Yu I., 1989, “Inductive detection of piezoelectric resonance by using a pulse NMR/NQR spectrometer”, Rev. Sci. Instrum. 60, 3249-3252). An electromagnetic process termed magnetic direct generation (MDG), was found to occur several years earlier in the easier to recognise case of metals resonating in and around the NMR test chamber. The process was first discovered in 1955 in Russia (Aksenov, S. I., Vikin B. P., 1955, Sov. Phys. DEPT Lett. 28, 609) and was followed in the US in 1964, when NMR signals were found with ringing responses related to wire dimensions (Clark, W. G., 1964. Rev. Sci. Instrum. 35, 316).

However, there are problems with the known arrangements. Sensitivity can only be improved by using thinner crystals. However these become too fragile when thicknesses are less than 200 μm. Even at these minimal thicknesses perturbations of only <0.01% ,in the acoustic frequency of the resonator are produced, demanding careful tracking of the resonance frequency for sensor operation. In addition, the dimensions of the molecules of interest range from 5 to 20 nm, a substantial amount (>95%) of acoustic transverse coupling is to the fluid above the chemical interface, essentially outside of the domain of the analysis in which there is interest.

An evanescent sensing region that is significantly thicker than the chemical layer of interest leads to reduced sensitivity and interpretation complications. For example, optical SPR (surface plasmon resonance) sensors generate a 200 nanometre evanescent wave, that is supposed to measure the refractive index of a protein layer, and yet it is the composite refractive index of the film and more significantly the fluid that is determined. Similarly, electroded piezoelectric crystals known as TSMs (thickness shear mode) or QCMs (quartz crystal microbalances) operate at 10 MHz, which also have an evanescent penetration depth that reaches beyond the chemical layer of interest. Focusing the evanescent wave towards the interface has been attempted with magnetic acoustic resonance sensors that work at 50 MHz; however wave penetration still overshoots the interfacial chemistry with losses in sensitivity. Surface acoustic wave devices known as Love wave devices can work at higher frequencies for smaller penetration depths; however none of these systems provide a sufficiently compact evanescent zone to fully recover the biochemical signal.

A further restriction of these sensors is that a very limited window of information is recovered, at a single wavelength or frequency. This is tantamount to operating an IR spectrometer at a single wavelength, which severely reduces the value of the data recovered.

With respect to the practical format of these systems, all optical and acoustic devices require additional layers of metallization to be applied and patterned, which for the interdigitated pattern on SAW (surface acoustic wave) is an especially costly process. In use, optical sensing systems require careful alignment and isolation from sources of vibration, whilst the materials used in MARS (magnetic acoustic resonance sensors) and SAW are sensitive to temperature and demand careful environmental control in order to function without signal drifts. Wire connections to QSM and SAW devices are required, which reduces compatibility with chemical immobilisation modifications and procedures and places design constraints on commercial instruments.

There is thus a continuing need for sensors to be improved, especially in the diagnostics, healthcare and pharmaceutical industries in order to provide high throughput of data at lower cost per measurement in a less invasive and bulky instrument that does not sacrifice sensitivity.

This invention aims to substantially enhance the characteristics of the MARS system by reducing the size of the sensing element to micron dimensions and making it accessible to electromagnetic interrogation over greater distances (several centimetres) such that it can operate as a truly remote sensing element that is the unique in requiring no antenna, metallization or circuitry, whilst providing MHz-GHz spectroscopic measurements. In this guise, the enhanced format is analogous to nuclear magnetic resonance except that damping is not provided by the precession of an atomic nucleus in a magnetic field but by damping of a minute crystal fragment by interfacial chemical forces. Here, sensitivity increases proportionately as the fragment size is reduced.

Bearing in mind the above, it is an object of the present invention to solve the problems identified in the prior art. Thus, it is an object of the present invention to provide an improved sensing apparatus and method.

### SUMMARY OF THE INVENTION

Accordingly, the present invention provides a remote sensing apparatus comprising:
(a) an electromagnetic field detector and
(b) an acoustic resonator comprising an electromagnetic field generator, and a sensing material in wireless communication with the generator;
   wherein the sensing material is in wireless communication with the detector, and an acoustic property of the sensing material is responsive to a change in state of an environment to which the sensing material is exposed, and wherein the sensing material is in the form of one or more particles and/or fragments.

An important advantage of the present invention is that the inventors have found a solution to the sensitivity limitation of conventional acoustic resonator sensors. The sensitivity of these devices could theoretically be improved, but this would have demanded acoustic sensors thinner than 200 μm. This limitation formerly restricted any sensitivity improvement, because the devices became too fragile. However the present invention has no such limitation as it allows sensing devices to shrink laterally as well as in the thickness direction, by using fragments or particles, so robustness is maintained. For example a 1 μm thick device will have 200 times the mass sensitivity of a 200 μm thick device.

The sensing apparatus of the invention can be used in arrays, microfluidic systems, tubes, reaction vessels and as RFID smart tags avoiding transport of the sample to the measurement instrument for analysis. Complicating wires or connections are avoided benefiting measurement applications in small reaction chambers, microfluidic chamber or subcutaneously. The invention uses a radio link to wireless acoustic sensors that are supremely simple. They provide the user with a freedom similar to mobile phones. Here an electrically active material alone, with no support of any kind, can behave as a receiver, acoustic sensor, transmitter and antenna. The sensing elements cannot run out of power or fail as the intrinsic property of the material does not disappear. The improved and sharper resonances of the smaller sensor fragments are illustrated in the examples herein, whilst it is demonstrated that quartz fragments can be placed in a fluid filled beaker that is linked by radio to a toroidal antenna. This demonstrates that the sensing element can be made smaller, boosting sensitivity inversely to its thickness. Thus gains in sensitivity of 100 fold or more can be achieved while reducing any strain on the environment it is located in. Non-biological applications involving smart tags, temperature sensitivity, viscosity sensitivity, humidity, spoilage, cars, engines, aeronautics and space are also envisaged.

The invention will now be described in more detail, by way of example only, with reference to the following figures, in which

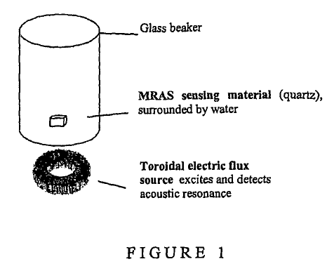

FIG. 1 shows a test format used to excite piezoelectric disc and fragments inside a glass beaker; the source is a toroidal transformer, which generates electric flux to both excite vibration in the disc, and to detect this vibration;

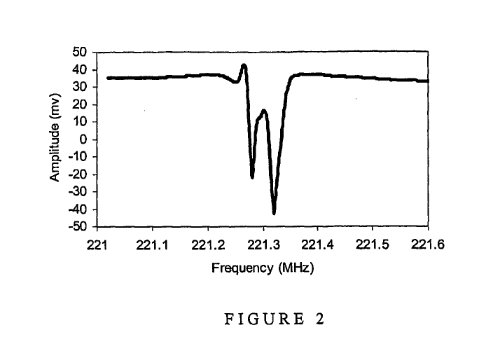

FIG. 2 shows a harmonic acoustic resonance in a 12 mm diameter 0.25 mm thick piezoelectric AT quartz disc (in air); there are two side resonances that correspond to nanometre-sized thickness differences across the disc, created by a typical lapping process;

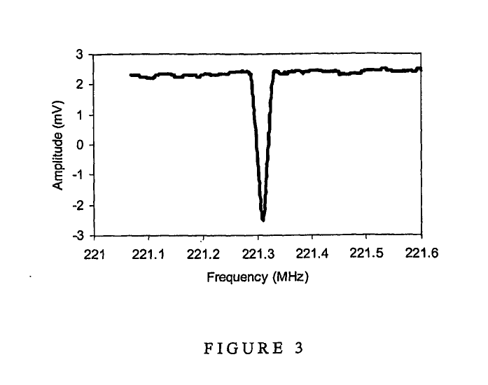

FIG. 3 shows the more defined acoustic resonance of a 2×2 mm AT quartz fragment (in air) sourced from the ‘broken’ 12 mm disc of FIG. 2;

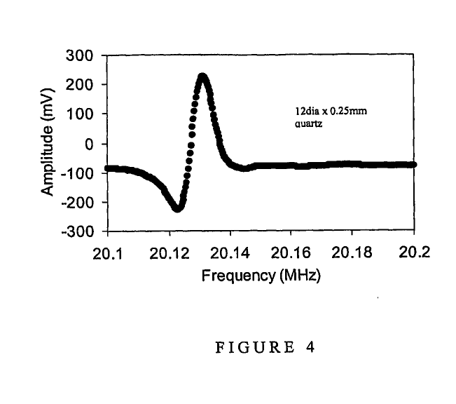

FIG. 4 shows acoustic resonance of a different 12 mm diameter 0.25 mm thick piezoelectric AT quartz disc (completely immersed in de-ionised (DI) water; and

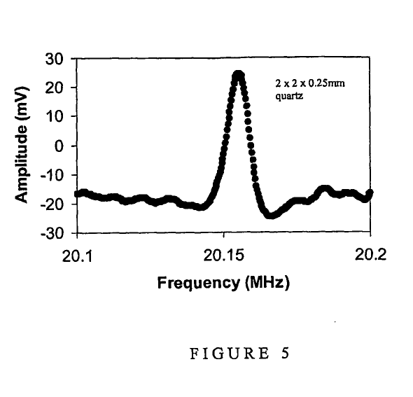

FIG. 5 shows acoustic resonance of a 2×2×0.25 mm piezoelectric AT quartz fragment, completely immersed in DI water.

### DETAILED DESCRIPTION OF THE INVENTION

A feature of the microscale remote acoustic spectroscopy (MRAS) system of the present invention is the appearance of a significant electric field several centimetres from the antenna that drives a miniature quartz crystal by the converse piezoelectric effect, without electrodes. MRAS displays many advantages compared to other current biochemical diagnostics. These include:

1. Multiple frequency operation over the MHz to GHz range to obtain acoustic spectra or ‘fingerprints’ that may be associated with specific molecular species.

2. Use of a sub-mm quartz element (the microcrystal) that has intrinsic telemetry and sensing functionality, thereby obviating the requirement for transmitters, receivers, other sensors, or antennae.

3. Minimal perturbation of the sample to be measured because of the sub-mm size of the microcrystal and remote interrogation.

4. Opportunity to make plastic or similar composites from microcrystals in order to fabricate functional arrays.

5. A simple format that lends itself well to biochemical measurements in immersed or subcutaneous samples.

Proof of the MRAS concept is demonstrated in the Examples, and has been achieved by exciting a quartz crystal blank and a smaller fragment with a toroidal antenna operating through the wall of a glass beaker.

The remote sensing apparatus or system of the present invention comprises the following elements:
(a) an electromagnetic field detector and
(b) an acoustic resonator comprising an electromagnetic field generator, and a sensing material in wireless communication with the generator;
   wherein the sensing material is in wireless communication with the detector, and an acoustic property of the sensing material is responsive to a change in state of an environment to which the sensing material is exposed, and wherein the sensing material is in the form of one or more particles and/or fragments.

Typically the resonator comprises an electromagnetic field generator and a sensing material in wireless communication with the generator, wherein the generator is arrangable to direct an electromagnetic field towards the sensing material. It is preferred that the electromagnetic field generator and the detector comprise a common structural element for generating an electromagnetic field and detecting an electromagnetic field.

In the context of the present invention, the environment to which the resonator (or the sensing material of the resonator) is exposed is generally provided by the presence of a sample in close proximity to the sensing material such that the sample environment affects the properties of the sensing material. The environment or sample will itself have a property that the user wishes to determine using the sensing device. The environment, and thus the sample, is not especially limited and may be any sample to be investigated. Thus the sample may include biological samples, reaction environments, engineering environments and the like. The property to be determined by the sensing is also not especially limited, and may include a biological property, such as DNA hybridisation, protein conformation change and antigen-antibody interaction, or a physical property such as the temperature in an engine, or quantity of vapour above a reaction mixture.

In order to carry out sensing, the resonator (or the sensing material of the resonator) is placed in the desired environment and the detector placed at a suitable distance from the resonator for detection. This distance is not especially limited and may vary depending on the dimensions of the detector and the size of the electromagnetic field employed. Typically a distance of from 1-100 mm is employed, more preferably from 1-50 mm.

In preferred embodiments of the invention, the electromagnetic field generator is tunable. The source of the electromagnetic field is not especially limited, provided that it is sufficient to excite the acoustic resonance in the resonator (the sensor material). Preferably, the electromagnetic field generator comprises an electrode or a coil, such as a spiral coil, or most preferably a toroidal coil. The electrode or coil may comprise any conductive material, but is preferably a metal or a metal alloy, and is typically formed from a single wire. The metal is not especially limited, but preferably comprises copper. The dimensions of the electromagnetic field generator and the source are not particularly restricted, and may be selected depending on the application to which they are directed. Typically the coil may have a diameter of 100 mm or less, more preferably from 1-50 mm, and most preferably from 5-25 mm.

In further preferred embodiments of the invention, the apparatus comprises a signal generator and a lock-in amplifier connected to the electromagnetic field generator and the detector. Typically, the detector comprises a differential diode demodulation circuit for subtracting a detected signal from a signal produced by the signal generator.

The sensor material is not especially limited, provided that its acoustic properties are affected by at least one type of environment and can be detected using the detector. Preferably, the sensor material comprises a material with an electric or a magnetic dipole. Preferably a piezoelectric material is employed, because it may often be readily found in plate form. The piezoelectric material employed is not especially limited, but typically the piezoelectric material comprises quartz. Other materials that may be employed include lithium niobate, lithium tetraborate, lithium tantalate and PVDF. The form of the material is not particularly limited, and may be a whole crystal, or fragments of a crystal, typically fragments having substantially equidistant surfaces, such as a plate or a spherical bead. Typically the sensing material is in the form of one or more particles. Various composite materials and configurations may be used, depending on the application involved, such as a hydrogel layer situated on the sensor material, or a fragment embedded in another substance such as a larger plastic article (e.g. a tag). In preferred embodiments of the present invention, the average diameter of the particles is from 0.1-1000 μm, more preferably from 1-100 μm.

The present invention further provides use of the sensing apparatus as defined above in a method of sensing. Since this invention provides a platform technology there are many possible uses, dictated by the chemistry taking place at the interface, in other words, dictated by the extremely varied nature of the environments to which the resonator or the sensor material is responsive. Preferred uses include, but are not limited to, in a sensor array, a microfluidic system sensor, a reaction sensor, a radio frequency identification (RFID) smart tag, a biological sensor, a subcutaneous sensor, a temperature sensor, a viscosity sensor, a spoilage sensor (such as a sensor for detecting a pH change due to bacterial activity that leads to degradation in food, which pH change can then be correlated to food quality), and an engine sensor where the element requires no power supply. Preferred biological uses include as a glucose sensor for measurement via an in vivo or in vitro antenna, or an affinity sensor whereby the surface is immobilised with molecular receptors, targeted e.g. at neurodegenerative disease detection, or at anomalous blood proteins associated with heart disease.

Further provided by the present invention is a method of controlling a system based upon a change in the surrounding environment using a sensing apparatus as defined above.

Without being bound by theory, further explanation of the principles of the apparatus or system is provided in the following.

The electric field of a spiral coil circulates in the same plane as the wire turns themselves and decays rapidly with the separation distance. Instead the dominant electric field which excites the crystal between each wire turn of the spiral coil as where there is a local potential difference. Both of these inductive and capacitive fields as they are known do not extend with significant fields more than 0.2 mm. A solution to this problem is to realise that an antenna configuration to provide a circulation of magnetic the field needs to be arranged. A toroid antenna is capable of circulating the magnetic field through the circular axis of the toroid to get the electric flux through the centre of the toroid. Hence the vector field of B is a curl:

$$curl B = - {μ}_{0} {ɛ}_{0} \frac{d E}{d t}$$

Hence this circulating magnetic field in the toroid is accompanied by a central and extending electric flux. The voltage detected by the toroidal coil is dependent on the number of turns (N) the toroid area (A) the operating frequency (f) and the current (I) at resonance.

V₀=NAd I_{f0}.f

However impedance matching and electrical noise associated with the geometry must also be considered. The relative orientation of the toroid and the crystal also determine the signal amplitude, but do not affect the Q value of the resonance or the crystal resonance frequency. The equation below relates the angular orientation of the AT crystal Y axis with the vertical and horizontal electric fields (Eᵥ and Eₕ)

Xₕ=K[Eᵥ Cos(φ)+Eₕ Sin(φ)]

Whilst this second equation relates the horizontal electric field (Eₕ) with the angle of the AT crystals X axis:

Xₕ₂=K₂[Eₕ Cos(Θ)]

The boundary between the crystal and the surrounding medium can also be a source of a contributory electric field. The following expression relates the electric field vector (E) across the dielectric gradient at the boundary of the crystal, with the emergent driving charge:

$$σ = - \frac{{ɛ}_{0}}{ɛ} E \cdot ▽ɛ$$

This equation quantifies the amount of charge σ appearing in a system with variable dielectric properties when subjected to an electric field E (ε₀ is the electric permittivity of the free space and ∈ is the relative electric permeability of the solvent). According to Gauss' law, such polarization charges in dielectrics are the source of further electrical fields:

$$E = \frac{σ}{ɛ}$$

Since the crystal-solution and the crystal-air interfaces, where the charge appears, are plane and parallel, the field is necessarily uniform and perpendicular to the crystal faces, such that it produces interfacial charge like a conventional parallel electrode structure of a quartz crystal. The acoustic resonances, which arise from these driving forces, appear at frequency intervals corresponding to a harmonic series of standing wave resonances given by the frequencies:

$$f = \frac{{nV}_{sh}}{λ}$$

where Vₛₕ is the velocity of the shear wave in the quartz, n is the mode number of the resonance and λ is the acoustic wavelength. The crystal behaves as an acoustic sensor since deposition of a film extends the shear acoustic standing wave contained between its faces. In the simplest case, for a plate vibrating in air, the magnitude of the frequency change observed when thin metal films are deposited on the upper face is described by a form of the Sauerbrey equation, which recognises the multiple harmonic frequencies suitable for acoustic sensing. The main characteristics to be extracted from this and other standard acoustic sensing models are their frequency dependency, which in the case of Sauerbrey can be reformulated to a linear relation:

Δf=[Δm_{f}/M_{R}]f

and Kanazawa to a square root relation:

Δf=[(ρₗηₗ)^{1/2}/(2π^{1/2} ρ_{R}t_{R})]\sqrt{f}

where K₁=Δm_{f}/M_{R}, the ratio of the film mass to the resonator mass, and K₂=(ρₗηₗ)^{1/2}/(2π^{1/2}ρ_{R}t_{R}), which is analogous to the ratio of the in phrase fluid ‘mass’ to the resonator mass.

Here the important aspect to notice is the response in both cases depends on the size and mass of the resonant element. Size reductions substantially increase sensitivity. Not having to make connections to the device means its width may be shrunk, but this has the benefit of making the crystal less liable to breakage. As the device gets smaller it becomes more robust so it can continue to be shrunk in size.

The present invention will now be described by way of example only with reference to the following specific embodiments.

### Examples

Materials and Methods

Discs

Piezoelectric AT crystal blanks 12 mm in diameter and 0.25 mm thick were prepared to a fine optical polish. Devices were cleaned in chloroform, then acetone and finally isopropanol.

Fragments

The same piezoelectric crystal was also broken into approximately 40 to 50 pieces for testing. All fragments had resonance frequencies and amplitudes that would different from each other.

Beads

Beads or fragments with chemical coatings provide an ideal opportunity for accessing wirelessly chemical environments in tubes, chambers, microfluidics and arrays used in biotechnology. They can be frequency ‘tagged’ so that a large number of sensors can be scanned with a single coil.

Measurement Equipment

Toroid Z Measurements

The equipment selected for the measurement was the Hewlett Packard impedance analyser which operates at up to 1.8 GHz. It allows sample positioning at the measurement head so cable contributions to the impedance are minimal. The complex impedance was measured for the toroid over the range 1-50 MHz in order to identify how antenna impedance contributed to the acoustic response. Scan rates were set to once per minute to maximise the signal to noise ratio. Acoustic amplitudes were centred with the marker positioning and waveform measuring tool. Equivalent circuit analysis provided inductance, capacitance and resistance values for the assumed inductance and resistance in parallel with the capacitance.

Acoustic Signal Collection

Signal recovery is normally performed with a frequency modulated signal generator, AM detector and lock-in amplifier. The signal recovered will be a differentiated conversion of the acoustic resonance envelope. The resonance frequency will be determined from either the zero crossing of the envelope or the detected zero phase, whilst amplitude measurements are taken from the lowest point on the resonance curve to the highest point. Changes in amplitude or frequency will be measured over 100 or more harmonic frequencies. As a zero field NMR has been optimised over several years, it is a useful reference point from which to establish the signal-to-noise performance of the detection system that is being used. The skilled person may establish whether the microcrystal inserted within a helical coil form as opposed to a microcrystal placed in proximity to a planar spiral coil form is more efficient.

Antenna E-Field Source

The toroidal coil is made of a doughnut shaped magnetic material that has the enamelled copper wire wound through and around the doughnut making turns totalling from 2 to 200 turns. In this configuration it can be used for incorporation in tuning circuits, however it was desired to use the toroid not to tune circuits but in order to make electric fields that penetrate several millimetres away from the centre of the toroid itself. Alternatively the toroid can be an enclosure around a tube or test-tube such that any piezoelectric fragments located within the central region of the toroid will be detected with great efficiency indeed, achieving performances that are much improved relative to electrode type detection strategies. The main problem with toroidal coils is simply to wind them and to be able to choose the appropriate magnetic material upon which they are based. However, the skilled person may readily select materials from those already known, to achieve the required performance, to avoid parasitic inductances or capacitances that detract from their performance of the toroidal antenna.

Results and Discussion

Acoustic Measurements of Disc Versus Fragments

The toroidal coil through producing a circulation of the magnetic field, generates a secondary electric field through the centre of the core that practically has greater non-contact lift off properties compared to the other antennas. As the toroid produces better lift off characteristics than the spiral coil or electrode, it is possibly the best alternative overall when its impedance is suitably modified.

After assembling the test equipment, numerical analysis of the toroid using a time-dependent electromagnetic model based on a finite element analysis approach was used to initiate a program to predict the electric field distribution. The resulting electric field direction relative to the crystal axes will also be of great interest in developing a full electromechanical description of the physical properties of the device. However, to obtain an immediate indication of performance prior to optimisation, the toroid size was varied directly and variations in coupling efficiency noted.

One of the first complications associated with the signals received from the microcrystals is the interpretation of the different acoustic modes present in the resonance spectrum. Much smaller crystals with significantly different aspect ratios and potentially lower Q factors may incorporate a mixture of torsional, radial, longitudinal and flexural modes which will need to be evaluated relative to the strength of the shear acoustic mode which it is desired to utilise. In practise it was found that the smaller crystals and the fragments had purer resonances. Below are comparisons of a whole crystal (FIG. 2) and a crystal fragment of the same whole crystal (FIG. 3) measured with a non-contact electric field.

More detailed analysis of the fragment (FIG. 3) indicated that the low and harmonic structure of the original crystal was not present. An observation ascribed to the reduced width of the crystal fragments relative to the whole, minimising the thickness variations.

Toroid Measurements of Crystals in a Beaker

The action of placing the whole disc in a water filled beaker was to damp any extraneous resonances, even of the larger disc (FIG. 4). The resonance was pure and strong and exposed to water on both sides. Although there is some electrical shorting from one side to the other this does not appear to load the resonance and damp it significantly. In fact the presence of the water dielectric tends to amplify the overall response. The smaller fragment generated a smaller response (FIG. 5). However, the resonance was sharper owing to the smaller variation in thickness.

The present invention provides an improved system and method for truly non-contact operation that is superior to well characterised quartz crystal resonators. It uses miniature quartz fragments that function continuously without a power supply, microelectronics, parts or processing of any kind. It can be implanted or incorporated into a chemical environment to ‘report’ its chemical status. More sensitivity through less vibratory size, convenience through the lack of need for a connection, and less invasiveness due to the small size of the element and multiple frequency operation for acoustic ‘fingerprinting’.

1. A remote sensing apparatus comprising:
(a) an electromagnetic field detector and
(b) an acoustic resonator comprising an electromagnetic field generator, and a sensing material in wireless communication with the generator;
wherein the sensing material is in wireless communication with the detector, and an acoustic property of the sensing material is responsive to a change in state of an environment to which the sensing material is exposed, and wherein the sensing material is in the form of one or more particles and/or fragments.

2. A sensing apparatus according to claim 1, wherein the generator is arrangable to direct an electromagnetic field towards the sensing material.

3. A sensing apparatus according to claim 1 or claim 2, wherein the electromagnetic field generator and the detector comprise a common structural element for generating an electromagnetic field and detecting an electromagnetic field.

4. A sensing apparatus according to any preceding claim, wherein the electromagnetic field generator is tunable.

5. A sensing apparatus according to any preceding claim, wherein the electromagnetic field generator comprises an antenna element formed from an electrode, a spiral coil, a toroidal coil, an embedded patch antenna, or from another suitable antenna element.

6. A sensing apparatus according to any preceding claim, comprising a signal generator and a lock-in amplifier connected to the electromagnetic field generator and the detector.

7. A sensing apparatus according to claim 6, wherein the detector comprises a differential diode demodulation circuit for subtracting a detected signal from a signal produced by the signal generator.

8. A sensing apparatus according to any preceding claim, wherein the sensor material comprises polarised electric or magnetic dipoles.

9. A sensing apparatus according to any preceding claim, wherein the sensor material comprises a piezoelectric material.

10. A sensing apparatus according to claim 9, wherein the piezoelectric material comprises quartz, lithium niobate, lithium tetraborate, lithium tantalate and PVDF.

11. A sensing apparatus according to any preceding claim, wherein the sensor material is in the form of a single non-composite piece of that material.

12. A sensing apparatus according to any preceding claim, wherein the sensing material is in the form of one or more layers.

13. A sensing apparatus according to claim 11 or claim 12, wherein the average diameter of the piece and/or particles is from 0.1-1000 μm.

14. A sensing apparatus according to any preceding claim, wherein the particle is substantially spherical, substantially elliptical, substantially cylindrical, substantially rectangular, or is extended along a single axis, such as in the manner of a fibre, a cantilever or a nanotube.

15. Use of the sensing apparatus according to any preceding claim in a method of sensing.

16. Use of the sensing apparatus according to any one of claims 1-14 in a sensor array, a microfluidic system sensor, a reaction sensor, an RED smart tag, a biological sensor, a subcutaneous sensor, a temperature sensor, a viscosity sensor, a spoilage sensor, and an engine sensor.

17. Use according to claim 15 or claim 16, wherein the environment comprises a liquid phase environment, a vapour phase environment, or a gas phase environment.

18. Use according to any of claims 15-17, for the detection of one or more cells, peptides, oligopeptides, proteins, haptens, antigens, antibodies, nucleotides, oligonucleotides, nucleic acids and/or drugs or pharmaceuticals.

19. A method of controlling a system based upon a change in the surrounding environment using a sensing apparatus as defined in any of claims 1-14.

20. A method according to claim 19, wherein deviations in the electrical impedance of the electromagnetic field generator are measured.

21. A sensing apparatus substantially as described herein with reference to FIGS. 1-5 of the accompanying drawings.

22. Use of the sensing apparatus substantially as described herein with reference to FIGS. 1-5 of the accompanying drawings.

23. A method of controlling a system substantially as described herein with reference to FIGS. 1-5 of the accompanying drawings.

24. A method of measuring a change in the surrounding environment substantially as described herein with reference to FIGS. 1-5 of the accompanying drawings.
